(19) United States
(12) Patent Application Publication
(10) Pub. No.: US 2023/0252418 A1
(43) Pub. Date: Aug. 10, 2023

(54) APPARATUS FOR CLASSIFYING CANDIDATES TO POSTINGS AND A METHOD FOR ITS USE

(71) Applicant: MY JOB MATCHER, INC. D/B/A JOB.COM, Austin, TX (US)

(72) Inventors: Arran Stewart, Austin, TX (US); Steve O'Brien, Raleigh, NC (US)

(73) Assignee: MY JOB MATCHER, INC. D/B/A JOB.COM, Austin, TX (US)

(21) Appl. No.: 17/667,617

(22) Filed: Feb. 9, 2022

(51) Int. Cl. G06Q 10/10; G06K 9/62

(52) U.S. Cl. CPC G06Q 10/1053; G06K 9/6269; G06N 20/10

(57) ABSTRACT

In an aspect an apparatus for classifying job candidates for a particular job posting is disclosed. The apparatus is comprised of at least a processor and a memory communicatively connected to the processor. The processor may be configured to receive job candidate datum wherein the job candidate data includes at least a video record. Additionally, the processor may be configured to extract record datum from the at least a video record. The processor may be further configured to classify the record datum to a candidate classification datum, Classifying may include training a candidate classifier using interview training data correlating interview data elements to candidate classification data elements and classifying the record datum to the candidate classification datum using the candidate classifier. The processor may also generate candidate match datum using a job posting machine learning model.

### FIELD OF THE INVENTION

The present invention generally relates to the field of human resource technology. In particular, the present invention is directed to an apparatus for classifying job candidates for a particular job posting.

### BACKGROUND

Classifying job candidates for job postings is an inexact process overly reliant on guesswork. Programmatic attempts to alleviate this issue are in turn hampered by a lack of knowledge on the part of the programmers themselves.

### SUMMARY OF THE DISCLOSURE

In an aspect an apparatus for classifying job candidates for a particular job posting is disclosed. The apparatus is comprised of at least a processor and a memory communicatively connected to the processor. The processor may be configured to receive job candidate datum wherein the job candidate data includes at least a video record. Additionally, the processor may be configured to extract record datum from the at least a video record. The processor may be further configured to classify the record datum to a candidate classification datum, Classifying may include training a candidate classifier using interview training data correlating interview data elements to candidate classification data elements and classifying the record datum to the candidate classification datum using the candidate classifier. The processor may also generate candidate match datum using a job posting machine learning model

In another aspect, a method of classifying job candidates for a job posting includes receiving, by a processor job candidate datum, wherein the job candidate data includes at least a video record, extracting, by a processor, an record datum from the at least a video record, training, by a processor, a candidate classifier using interview training data correlating interview data elements to candidate classification data elements, classifying, by a processor, the record datum to the candidate classification datum using the candidate classifier, and generating, by a processor, candidate match datum using a job posting machine learning model.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of an apparatus for classifying job candidates for a job posting.

FIG. 2 is a block diagram illustrating an exemplary embodiment of a chatbot;

FIG. 3 is a block diagram illustrating an exemplary embodiment of a machine learning model;

FIG. 4 illustrates an exemplary nodal network;

FIG. 5 is a block diagram of an exemplary node;

FIG. 6 is a graph illustrating an exemplary relationship between fuzzy sets;

FIG. 7 is a flow diagram of an exemplary method for an apparatus for classifying job candidates for a job posting; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for an apparatus for classifying job candidates for a particular job posting is disclosed. The apparatus may be comprised of at least a processor and a memory communicatively connected to the processor. The processor may be configured to receive job candidate datum wherein the job candidate data includes at least a video record. Additionally, the processor may be configured to extract record datum from the at least a video record. The processor may be further configured to classify the record datum to a candidate classification datum, Classifying may include training a candidate classifier using interview training data correlating interview data elements to candidate classification data elements and classifying the record datum to the candidate classification datum using the candidate classifier. The processor may also generate candidate match datum using a job posting machine learning model.

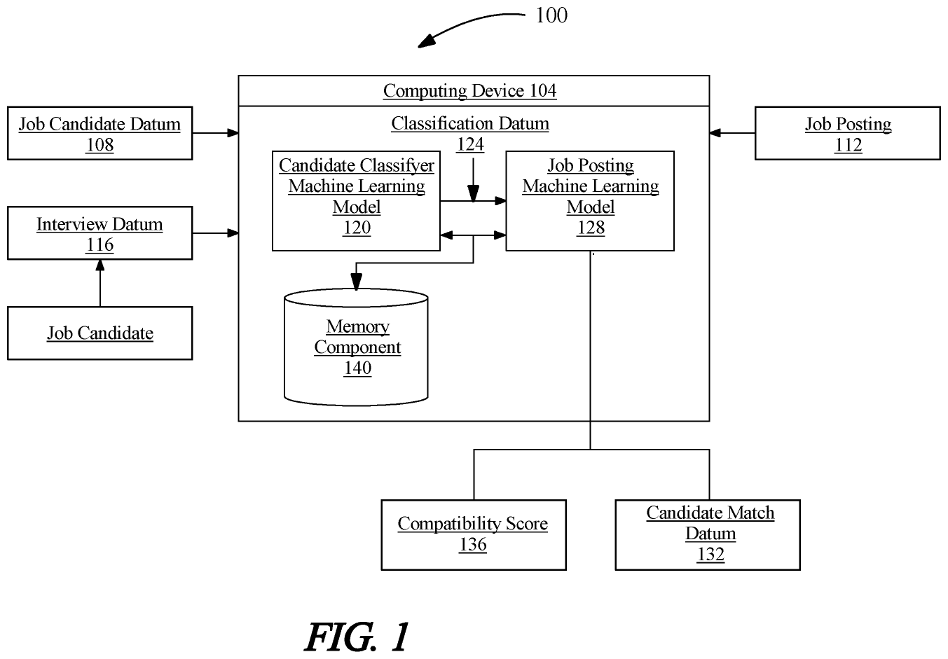

Referring now to FIG. 1, an exemplary embodiment of an apparatus 100 for classifying job candidates for a particular job posting is illustrated. System includes a computing device 104. computing device 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. computing device 104 may include a single computing device operating independently, or may include two or more computing device operating in concert, in parallel, sequentially or the like; two or more computing devices may be included together in a single computing device or in two or more computing devices. computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. computing device 104 may include but is not limited to, for example, a computing device or cluster of computing devices in a first location and a second computing device or cluster of computing devices in a second location. computing device 104 may include one or more computing devices dedicated to data storage, security, distribution of traffic for load balancing, and the like. computing device 104 may distribute one or more computing tasks as described below across a plurality of computing devices of computing device, which may operate in parallel, in series, redundantly, or in any other manner used for distribution of tasks or memory between computing devices. computing device 104 may be implemented using a “shared nothing” architecture in which data is cached at the worker, in an embodiment, this may enable scalability of system 100 and/or computing device.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing

With continued reference to FIG. 1, computing device 104 is further configured to receive a job candidate datum 108, as previously mentioned. For the purposes of this disclosure, “job candidate datum” is the candidates personal information and/or attributes relevant to a job position of a posting. Job candidate datum 108 may be audio and/or visual information related to the user's personal information, attributes, and/or credentials. For example, job candidate datum may be a video, audio file, text, and the like. Job candidate datum 108 may include a user's prior record, such as a resume, personal address, social security number, phone number, employment history, experience level, education, certification, acquired skills, geographical location, expected compensation, job performance acknowledgements (e.g., awards, honors, distinguishments), photograph of user, sample work product, and the like. Job candidate datum 108 may be received by computing device 104 by the same or similar means described above. For example, and without limitation, job candidate datum 108 may be provided by a user directly, database, third-party application, remote device, immutable sequential listing, social media profile, and the like. In non-limiting embodiments, job candidate datum 108 may be provided as independent or unorganized facts, such as answers to prompted questions provided by computing device 104 and/or as dependent or organized facts, such as a previously prepared record that the user made in advance.

With continued reference to FIG. 1, computing device 104 is configured to receive a job posting datum 112. For the purpose of this disclosure, “job posting datum” is information related to an available and/or open job position. For the purposes of this disclosure, a “job position” (also referred to in this disclosure as a “job”) is a paid occupation with designated tasks associated therewith. A job position may include an employment with an employer, such as work as an employee (part-time or full-time), intern, worker, contractor, self-employed, and the like. For example, and without limitation, job posting datum 112 may include information and/or data from a job posting and/or listing that describes an open job position. Job posting datum 112 may include a job position title, qualifications and/or requirements for the job position, expected responsibilities associated with the job position, benefits with the job position, compensation, geographical location, employer information, and the like. Job posting datum 112 may include information related to an employer's expectations of a person hired for such a job position. For instance, and without limitations, job posting datum 112 may include minimum qualifications that a candidate must possess to adequately perform the job position. Qualifications for job position may include education, certification, experience, desired skills and/or abilities, personal qualities, and the like. Job posting datum 112 may also include information that a person hired for the job position may expect from the job position. For instance, and without limitation, job posting datum 112 may include working hours for the job position, a type of salary, degree of professionalism, and the like. In one or more embodiments, job posting datum 112 may include a datum or a plurality of data related to an available job.

Still referring to FIG. 1, posting datum 112 described herein may be consistent with disclosure of in U.S. patent application Ser. No. 17/582,087, filed on Jan. 24, 2022 and titled “DIGITAL POSTING MATCH RECOMMENDATION APPARATUS AND METHODS,” which is incorporated herein by reference in its entirety.

In one or more embodiments, job posting datum 112 may be provided to or received by computing device 104 using various means. In one or more embodiments, job posting datum 112 may be provided to computing device 104 by a user, such as a jobseeker or potential job candidate that is interested in being a candidate or considered for a job position by the employer of the job position. A user may manually input job posting datum 112 into computing device using, for example, a graphic user interface and/or an input device. For example, and without limitation, a user may use a peripheral input device to navigate graphic user interface and provide job posting datum 112 to computing device 104. Non-limiting exemplary input devices include keyboards, joy sticks, light pens, tracker balls, scanners, tablet, microphones, mouses, switches, buttons, sliders, touchscreens, and the like. In other embodiments, job posting datum 112 may be provided to computing device 104 by a database over a network from, for example, a network-based platform. Job posting datum 112 may be stored in a database and communicated to computing device 104 upon a retrieval request form a user and/or from computing device 104. In other embodiments, job posting datum 112 may be communicated from a third-party application, such as from a third-party application on a third-party server, using a network. For example, job posting datum 112 may be downloaded from a hosting website for job listings. In one or more embodiments, computing device 104 may extract job posting datum 112 from an accumulation of information provided by a database. For instance, and without limitation, computing device may extract needed information from database regarding the job position and avoid taking any information determined to be unnecessary. This may be performed by computing device 104 using a machine-learning model, which is described in this disclosure further below.

With continued reference to FIG. 1, computing device 104 may be configured to extract record datum 116 from a job candidate. As used in the current disclosure, “record datum” is an element of datum that directly or indirectly provides a candidate's response to one or more elements of a questionnaire to gauge job candidates skill, credentials, aptitude the perform the job functions. Record datum 116 may be related to any subject matter relating to a job posting datum 112 or job candidate datum 108. Record datum 116 may be extracted from a video record. For example, record datum 116 may include subject attributes that are extracted from a video record 144. Another, example may include extracting record datum from the verbal visual or verbal content of the video record 114. The subject matter of the questions may include but are not limited to education, certification, experience, desired skills and/or abilities, personal qualities, and the like of a job candidate. Record datum may come in an audio, video, textual format. As used in the current disclosure, a “questionnaire” is set of questions that are devised for the purpose of extracting record datum from the job candidate. For example, a questionnaire may prompt the job candidate to respond to a set of questions by audio, visual, or textual means. A questionnaire may be given in a in the form of a survey. A questionnaire may have open ended questions, closed questions, multiple choice questions, rating scale, and the like. In some embodiments, a questionnaire may be a personality assessment of the job candidate. Computing device 104 may be configured to extract record datum 116 from a job candidate a user input.

With continued reference to FIG. 1, computing device 104 may be configured to extract record datum 116 from a job candidate using a chatbot. As used in the current disclosure, a “chatbot” is a computer program designed to simulate conversation with users such as candidates. A chatbot may accomplish this by presenting the job candidate with questions. Record datum 116 may be generated as a function of the job candidate responds. In the embodiments, a chatbot is designed to convincingly simulate the way a human would behave/respond as a conversational partner. A machine learning model may be configured to generate chatbot responses as a function of the record datum 116 as an input and output additional questions. In an embodiment, a chatbot may be configured to ask the questions from the questionnaire to a job candidate. Chatbot questions may also be generated as a function of the employers input. Additionally, a chatbot may be configured to respond to the candidate based on the candidate's responses. In other embodiments, a chatbot may prompt the user to respond to the questions in text or a video format. For example, a chatbot may verbally ask the job candidate questions prompting a job candidate to submit a video response. A chatbot then may convert the job candidates verbal responses to text. A transcript of the candidates responses to a chatbot may be displayed to an employer.

With continued reference to FIG. 1, record datum 116 may be received from a job candidate using a chatbot. A chatbot may be configured to provide a candidate or employer with a plurality of options as an input into the chatbot. Chatbot entries may include multiple choice, short answer response, true or false responses, and the like. A employer may decide on what type of chatbot entries are appropriate. In some embodiments, the chatbot may be configured to allow the employee to input a freeform response into the chat box. The chatbot may then use a decision tree, data base, or other data structure to respond to the users entry into the chatbot as a function of a chatbot input. As used in the current disclosure, “Chatbot input” is any response that a candidate or employer inputs in to a chatbot as a response to a prompt or question.

With continued reference to FIG. 1, the chatbot may classify candidates using chatbot input. A computing device 104 may be configured to analyze a candidate's input into the chatbot. The chatbot may be able to analyze a candidates text entries based on pre-determined set of factors, employer input, key words, composition, and clarity of candidates responses,. In embodiments, a computing device 104 may search for a synonyms or other equivalent words to the keywords and correlate those responses to the keywords. Additionally, candidates may be classified according to the chatbot input. Candidate classification may occur by identifying keywords within a candidates response and/or by employing a machine learning model in the form of a Chatbot input classifier. A keyword as it relates to a candidate may be any word that identifies a candidates skill, ability, and/or aptitude to fulfill the responsibilities of a job. A Chatbot input classifier may be trained using past chatbot inputs, job posting datum 112, record datum 116, and/or job candidate datum 108.

With continued reference to FIG. 1, Chatbot may output the next question based upon the Chatbot input. Candidates may be presented with various types of questions as a function of classification using a chatbot input. Each of the candidates responses will be input into the chatbot input classifier or analysis tools, creating a feedback loop. In embodiments, the questions may dig deeper into a candidates credentials or experience, and aptitude to fulfill a jobs requirements. The Chatbot may continue to produce questions about any given fact about the candidate until a terminal response is received or all of the questions run out. A candidates response may also trigger the chatbot to inquire about a different topic form the candidate. A terminal response is a response that will end the interview a prompt the candidate to close and or exit the chat bot. In embodiments, the chatbot generated questions may also be predetermined. This new process may occur by using a decision tree or other data structures.

With continuing reference to FIG. 1, computing device 104 may be configured to the respond to a chatbot input using a decision tree. A “decision tree,” as used in this disclosure, is a data structure that represents and combines one or more determinations or other computations based on and/or concerning data provided thereto, as well as earlier such determinations or calculations, as nodes of a tree data structure where inputs of some nodes are connected to outputs of others. Decision tree may have at least a root node, or node that receives data input to the decision tree, corresponding to at least a candidate input into a chatbot. Decision tree has at least a terminal node, which may alternatively or additionally be referred to herein as a “leaf node,” corresponding to at least an exit indication; in other words, decision and/or determinations produced by decision tree may be output at the at least a terminal node. Decision tree may include one or more internal nodes, defined as nodes connecting outputs of root nodes 156 to inputs of terminal nodes. Computing device 104 may generate two or more decision trees 152, which may overlap; for instance, a root node of one tree may connect to and/or receive output from one or more terminal nodes 160 of another tree, intermediate nodes of one tree may be shared with another tree, or the like.

Still referring to FIG. 1, computing device 104 may build decision tree by following relational identification; for example, relational indication may specify that a first rule module receives an input from at least a second rule module and generates an output to at least a third rule module, and so forth, which may indicate to computing device 104 an in which such rule modules will be placed in decision tree. Building decision tree may include recursively performing mapping of execution results output by one tree and/or subtree to root nodes of another tree and/or subtree, for instance by using such execution results as execution parameters of a subtree. In this manner, computing device 104 may generate connections and/or combinations of one or more trees to one another to define overlaps and/or combinations into larger trees and/or combinations thereof. Such connections and/or combinations may be displayed by visual interface to user, for instance in first view, to enable viewing, editing, selection, and/or deletion by user; connections and/or combinations generated thereby may be highlighted, for instance using a different color, a label, and/or other form of emphasis aiding in identification by a user. In some embodiments, subtrees, previously constructed trees, and/or entire data structures may be represented and/or converted to rule modules, with graphical models representing them, and which may then be used in further iterations or steps of generation of decision tree and/or data structure. Alternatively or additionally subtrees, previously constructed trees, and/or entire data structures may be converted to APIs to interface with further iterations or steps of methods as described in this disclosure. As a further example, such subtrees, previously constructed trees, and/or entire data structures may become remote resources to which further iterations or steps of data structures and/or decision trees may transmit data and from which further iterations or steps of generation of data structure receive data, for instance as part of a decision in a given decision tree node.

Continuing to refer to FIG. 1, decision tree may incorporate one or more manually entered or otherwise provided decision criteria. Decision tree may incorporate one or more decision criteria using an application programmer interface (API). Decision tree may establish a link to a remote decision module, device, system, or the like. Decision tree may perform one or more database lookups and/or look-up table lookups. Decision tree may include at least a decision calculation module, which may be imported via an API, by incorporation of a program module in source code, executable, or other form, and/or linked to a given node by establishing a communication interface with one or more exterior processes, programs, systems, remote devices, or the like; for instance, where a user operating system has a previously existent calculation and/or decision engine configured to make a decision corresponding to a given node, for instance and without limitation using one or more elements of domain knowledge, by receiving an input and producing an output represent rig a decision, a node may be configured to provide data to the input and receive the output representing the decision, based upon which the node may perform its decision.

Still referring to FIG. 1, computing device 104 may classify job candidates as a function of job candidate datum 108 and record datum 116. Job candidates may be classified based upon their skill, experience, and aptitude to fulfill the job functions of a job posting 112. For example, job candidates may be classified based any one or combination of skills as stated within a job posting 112. In another non limiting example, candidates may be classified based on their record datum 116. Candidates may be classified based on their experience, skills, availability, among other considerations. Candidates may be classified based on the absence or presence of any skill, trait, experience, as described by job candidate datum 108. In some embodiment, job candidates may be classified as a function of an employer input. As used in the current disclosure, an “employer input” is an element of datum that is added by the employer. In an embodiment, an employer input may include a specific trait that an employer want to see. In an non limiting example, grade point average above a certain number, a graduated with a degree in a given major/field , graduated from a specific schools, candidate location, candidate work experience, and the like.

With continued reference to FIG. 1, Computing device 104 may be configured to classify job candidates using a candidate classifier machine learning model 120. Whereas inputs to the to the machine learning model may include job candidate datum 108, record datum 108, and job posting 112. While the output to the machine learning model is classification datum 124. Classification training data is a plurality of data entries containing a plurality of inputs that are correlated to a plurality of outputs for training a processor by a machine-learning process to align to classify job candidates . Classification training data may contain information about the job candidate, job candidate datum 108, Job posting 112, record datum 116. Classification training data may include any alignment datum 132 stored in a database, remote data storage device , or a user input or device. Computing device 104 may candidate classifier using a classification algorithm, defined as a processes whereby a computing device 104 derives, from training data, a model known as a “classifier” for sorting inputs into categories or bins of data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, Computing device 104 may be configured to generate classification datum 124. As used in the current disclosure, “classification datum” is a manner of grouping job candidates as a function of record datum and/or job candidate datum. In embodiments, classification datum 124 may include sorting, grouping, matching, ranking of job candidates. Job candidates may be classified based on any combination of traits, skills, experiences disclosed within record datum and/or job candidate datum.

Still referring to FIG. 1, computing device may identify a plurality of candidate traits and classify these job candidates by any of their traits disclosed in record datum 112 or job candidate datum 108. Alternatively or additionally, computing device 104 may identify plurality of classification datum by querying a classification data base. using user-entered data. In an embodiment, “classification database” may include any data structure for ordered storage and retrieval of data, which may be implemented as a hardware or software module. classification database may be implemented, without limitation, as a relational database, a key-value retrieval datastore such as a NOSQL database, or any other format or structure for use as a datastore that a person skilled in the art would recognize as suitable upon review of the entirety of this disclosure. Data entries in a classification database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a classification database may reflect categories, cohorts, and/or populations of data consistently with this disclosure.

With continued reference to FIG. 1, machine-learning processes may include classification algorithms, defined as processes whereby a computing device 104 derives, from training data, a model for sorting inputs into categories or bins of data. Classification may be performed using, without limitation, linear classifiers such as without limitation logistic regression and/or naive Bayes classifiers, nearest neighbor classifiers including without limitation k-nearest neighbors classifiers, support vector machines, decision trees, boosted trees, random forest classifiers, and/or neural network-based classifiers.

Still referring to FIG. 1, computing device 104 may be configured to generate candidate classifier 120 using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(AB) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, computing device 104 may be configured to generate candidate classifier 120 using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: l=√Σ̅ᵢ̅₌̅₀̅ⁿ̅a̅ᵢ̅²̅, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values. As a non-limiting example, K-nearest neighbors algorithm may be configured to classify an input vector including a plurality of user-entered words and/or phrases, a plurality of attributes of a candidate data item, such as spoken or written text, objects depicted in images, metadata, or the like, to clusters representing themes.

Still referring to FIG. 1, candidate classifiers described herein may be consistent with disclosure of bias classifier in U.S. patent application Ser. No. 17/582,113, filed on Jan. 24, 2022 and titled “APPARATUS, SYSTEM, AND METHOD FOR CLASSIFYING AND NEUTRALIZING BIAS IN AN APPLICATION,” which is incorporated herein by reference in its entirety.

With continued reference to FIG. 1, Computing device 104 may be configured to generate candidate match datum 132 using a job posting machine learning model 128. Whereas inputs to the to the machine learning model may include classification job candidate datum 108, record datum 116, employer input, and job posting 112. While the output to the machine learning model is candidate match datum 132. Posting training data is a plurality of data entries containing a plurality of inputs that are correlated to a plurality of outputs for training a processor by a machine-learning process to align to match job candidates with job postings. Job posting training data may contain information about the job candidate, job candidate datum 108, Job posting 112, record datum 116, classification datum 124. Job posting training data may include any classification datum 124 or candidate datum 132 stored in a database, remote data storage device , or a user input or device.

In one or more embodiments, computing device 104 may implement a compatibility algorithm or generate a compatibility machine-learning module, such as machine-learning module 124, to determine a compatibility score 136 between user and job position. For the purposes of this disclosure, a “compatibility score” is a measurable value representing a relevancy of a user's characteristics with qualifications of a job position. In one or more non-limiting embodiments, compatibility score 136 may be a quantitative characteristic, such as a numerical value within a set range. For example, a compatibility score may be a “2” for a set range of 1-10, where “1” represents a job position and user having a minimum compatibility and “10” represents job position and user having a maximum compatibility. In other non-limiting embodiments, compatibility score 136 may be a quality characteristic, such as a color coding, where each color is associated with a level of compatibility. In one or more embodiments, if a compatibility score 136 is “low”, then a user and a job position are considered to have a minimum compatibility; if a compatibility score 136 is “high”, then a user and a job position are considered to have a maximum compatibility.

In one or more embodiments, computing device 104 may implement a compatibility algorithm or generate a compatibility machine-learning module, such as machine-learning module 128, to determine a compatibility score 136 between user and job position. For the purposes of this disclosure, a “compatibility score” is a measurable value representing a relevancy of a user's characteristics with qualifications of a job position. In one or more non-limiting embodiments, compatibility score 136 may be a quantitative characteristic, such as a numerical value within a set range. For example, a compatibility score may be a “2” for a set range of 1-10, where “1” represents a job position and user having a minimum compatibility and “10” represents job position and user having a maximum compatibility. In other non-limiting embodiments, compatibility score 136 may be a quality characteristic, such as a color coding, where each color is associated with a level of compatibility. In one or more embodiments, if a compatibility score 136 is “low”, then a user and a job position are considered to have a minimum compatibility; if a compatibility score 136 is “high”, then a user and a job position are considered to have a maximum compatibility.

For the purposes of this disclosure, a “compatibility algorithm” is an algorithm that determines the relevancy of a user's characteristics with qualifications of a job position. If user is considering applying to a plurality of job positions, then the compatibility scores between each job position of the plurality of job positions and the user may be ranked so that the user may determine which job position the user is most compatible with of the job positions. Compatibility algorithm may include machine-learning processes that are used to calculate a set of compatibility scores. Machine-learning process may be trained by using training data associated with past calculations and/or information for the job position and user, such as data related to past prior compatibility scores, job candidate datum 108, user datum history, posting datum 112, posting datum history, or any other training data described in this disclosure. Compatibility score 136 may be determined by, for example, if a certain numerical value of employment position data matches user data, where the more employment position data that matches user data, the higher the score and the greater the compatibility between the user and the job position. For example, and without limitation, posting datum 112 may include a qualification of requiring a teacher with at least five years of work experience, and job candidate datum 108 may include seven years of work experience in teaching, then a numerical value representing compatibility score 136 may be increased due to the data correlating, thus indicating user is more compatible for the job position because of the provided user datum 108. In an embodiment, compatibility algorithm may be received from a remote device. In some embodiments, compatibility algorithm is generated by computing device 104. In one or more embodiments, compatibility algorithm may be generated as a function of a user input.

In one or more embodiments, a machine-learning process may be used to determine compatibility algorithm or to generate a machine-learning model that may directly calculate compatibility score 136. In one or more embodiments, a machine-learning model may be generated using training data. Training data may include inputs and corresponding predetermined outputs so that a machine-learning module may use the correlations between the provided exemplary inputs and outputs to develop an algorithm and/or relationship that then allows the machine-learning module to determine its own outputs for inputs. Training data may contain correlations that a machine-learning process may use to model relationships between two or more categories of data elements. The exemplary inputs and outputs may come from a database, such as any database described in this disclosure, or be provided by a user. In other embodiments, a machine-learning module may obtain a training set by querying a communicatively connected database that includes past inputs and outputs. Training data may include inputs from various types of databases, resources, and/or user inputs and outputs correlated to each of those inputs so that a machine-learning module may determine an output, such as compatibility score 136, for an input, such as posting datum 112 and user datum 108. Correlations may indicate causative and/or predictive links between data, which may be modeled as relationships, such as mathematical relationships, by machine-learning processes, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements.

In one or more embodiments, apparatus 100 may further include a memory component 140. Memory component 140 may be communicatively connected to computing device 104 and may be configured to store information and/or datum related to apparatus 100, such as job posting datum 112, Job candidate datum 108, information related to record datum 116, information related to classification datum 124, candidate match datum 132, and compatibility score 136 and the like. In one or more embodiments, memory component 140 is communicatively connected to a processor and configured to contain instructions configuring processor to determine the record recommendation. Memory component 140 may be configured to store information and datum related to posting match recommendation. For example, memory component 140 may store previously prepared records (e.g., draft resumes), customized records generated by computing device 104, Job posting datum 112, Job candidate datum 108, candidate match datum 132, classification datum, and the like. In one or more embodiments, memory component may include a storage device, as described further in this disclosure below.

Still referring to FIG. 1, computing device 104 may be configured to acquire a plurality of video elements from a video record 144. As used in this disclosure, “video elements” are diverse types of features from a video record such as image features, frame features, sound features, graphical features, and the like. As used in this disclosure, a “video record” is a video in visual and/or audio form to provide a recording promoting a jobseeker; a video record may include a video resume. In some cases, video resume 144 may include content that is representative or communicative of at least attribute of subject. As used in this disclosure, a “subject” is a person, for example a jobseeker. Subject may be represented directly by video resume 144. For example, in some cases, image component may include an image of subject. As used in this disclosure, an “image component” may be a visual representation of information, such as a plurality of temporally sequential frames and/or pictures, related to video resume and target video resume. For example, image component may include animations, still imagery, recorded video, and the like. Attributes may include subject's skills, competencies, credentials, talents, and the like. In some cases, attributes may be explicitly conveyed within video resume 144. Alternatively, or additionally, in some cases, attributes may be conveyed implicitly with video resume 144.

Still referring to FIG. 1, video resume 144 may be representative subject-specific data. As used in this disclosure, “subject-specific data” is any element of information that is associated with a specific subject. Exemplary forms of subject-specific data include image component, video resume 144, non-verbal content, verbal content, audio component, as well as any information derived directly or indirectly from video resume 144 or any other subject-specific data. For example, subject-specific data could be the physical properties of subject, such as their body posture or facial expression. Subject-specific data could also be audio sensory properties of subject 120, such as tone of voice or background audio in a resume video 144.

In some cases, video resume 144 may include non-verbal content. As used in this disclosure, “non-verbal content” is all communication that is not characterized as verbal content. As used in this disclosure, “verbal content” is comprehensible language-based communication. For example, verbal content may include “visual verbal content” which is literal and/or written verbal content. Non-verbal content includes all forms of communication which are not conveyed with use of language. Exemplary non-verbal content may include change in intonation and/or stress in a speaker's voice, expression of emotion, and the like. For example, in some cases, non-verbal content may include visual non-verbal content. As used in this disclosure, “visual non-verbal content” is non-verbal content that is visually represented. In some cases, visual non-verbal content may be included within video resume 144 by way of image component.

In some cases, a non-verbal classifier may classify non-verbal content present in one or more image component to one or more of video resume 144, a feature. Non-verbal classifier may include a number of classifiers, for example each being tasked with classifying a particular attribute or form of non-verbal content. For example, in some cases, non-verbal classifier may classify a video resume 144 and related subject as associated with a feature representative of ‘personable.’ Non-verbal classifier may include another specialized visual non-verbal classifier to classify visual non-verbal content as appearing ‘personable’ that is, for example, as having appropriate posture, facial expressions, manner of dress, and the like. In some cases, classifier may include or a constituent part of tree structure, for making associations based upon video resume.

With continued reference to FIG. 1, in some embodiments, image component may include or otherwise represent verbal content. For instance, written or visual verbal content may be included within image component. Visual verbal content may include images of written text represented by image component. For example, visual verbal content may include, without limitation, digitally generated graphics, images of written text (e.g., typewritten, and the like), signage, and the like.

Still referring to FIG. 1, in some embodiments, image component may include or otherwise represent audible verbal content related to at least an attribute of subject. As used in this disclosure, “audible verbal content” is oral (e.g., spoken) verbal content. In some cases, audible verbal content may be included within video resume 144 by way of an audio component. As used in this disclosure, an “audio component” is a representation of audio, for example a sound, a speech, and the like. In some cases, verbal content may be related to at least an attribute of subject. Additionally, or alternatively, visual verbal content and audible verbal content may be used as inputs to classifiers as described throughout this disclosure.

In some cases, computing device 104 may include audiovisual speech recognition (AVSR) processes to recognize verbal content 136 in video resumes 144. For example, computing device 104 may use image content to aid in recognition of audible verbal content such as viewing subject move their lips to speak on video to process the audio content of video resume 144. AVSR may use image component to aid the overall translation of the audio verbal content of video resumes 144. In some embodiments, AVSR may include techniques employing image processing capabilities in lip reading to aid speech recognition processes. In some cases, AVSR may be used to decode (i.e., recognize) indeterministic phonemes or help in forming a preponderance among probabilistic candidates. In some cases, AVSR may include an audio-based automatic speech recognition process and an image-based automatic speech recognition process. In some cases, AVSR may convert verbal content into text. AVSR may combine results from both processes with feature fusion. Audio-based speech recognition process may analysis audio according to any method described herein, for instance using a Mel frequency cepstrum coefficients (MFCCs) and/or log-Mel spectrogram derived from raw audio samples. Image-based speech recognition may perform feature recognition to yield an image vector. In some cases, feature recognition may include any feature recognition process described in this disclosure, for example a variant of a convolutional neural network. In some cases, AVSR employs both an audio datum and an image datum to recognize verbal content. For instance, audio vector and image vector may each be concatenated and used to predict speech made by a subject, who is ‘on camera.’

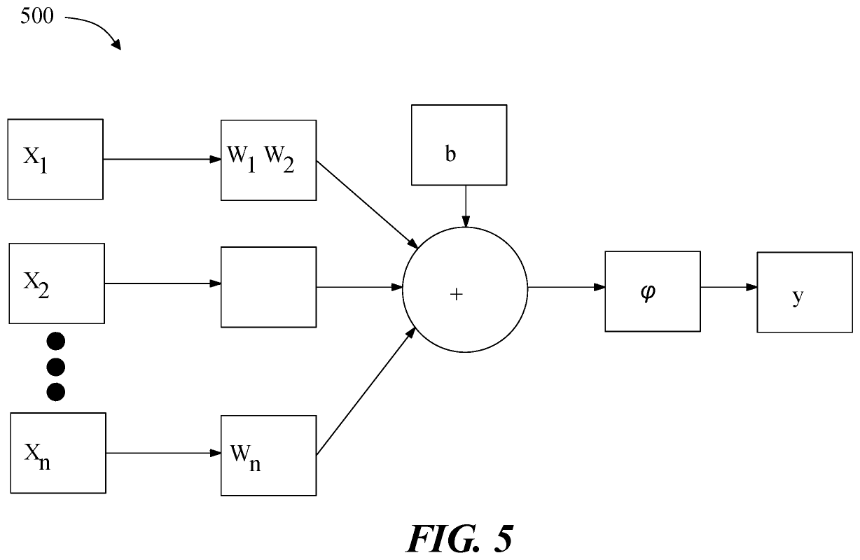

With continued reference to FIG. 1, computing device 104 may transcribe at least a keyword 136. Computing device 104 may transcribe at least a keyword as a function of one or more of image component and audio component. Computing device 104 may transcribe at least a keyword as a function of verbal content. As used in this disclosure, a “keyword” is any meaningful word or syntax. In some cases, computing device 104 may transcribe much or even substantially all verbal content from video resume 144. In some cases, computing device 104 may transcribe audible verbal content, for example by way of speech to text or speech recognition technologies. Exemplary automatic speech recognition technologies include, without limitation, dynamic time warping (DTW)-based speech recognition, end-to-end automatic speech recognition, hidden Markov models, neural networks, including deep feedforward and recurrent neural networks, and the like. Generally, automatic speech recognition may include any machine-learning process described in this disclosure, for example with reference to FIGS. 5-8.

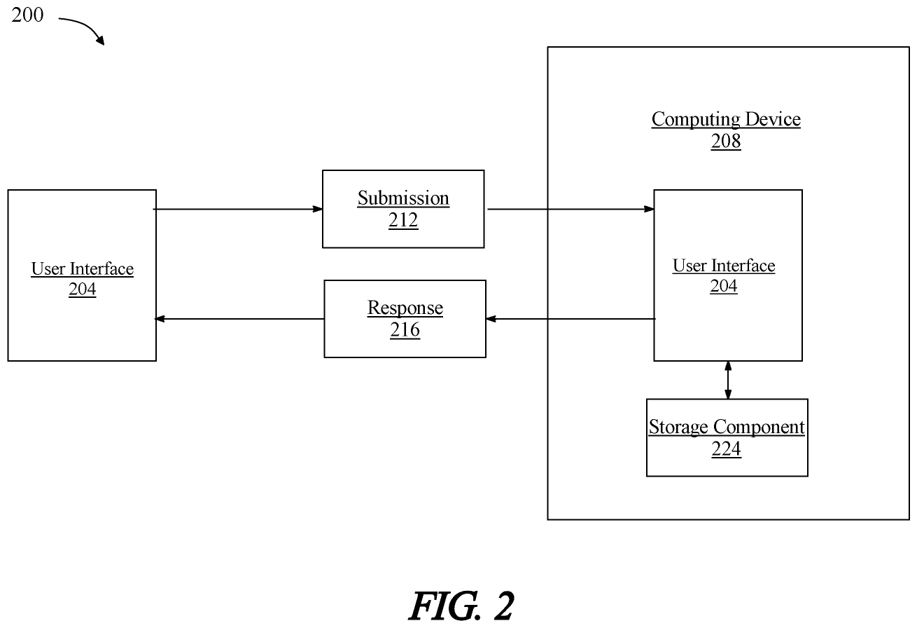

Referring to FIG. 2, a chatbot system 200 is schematically illustrated. According to some embodiments, a user interface 204 may be communicative with a computing device 208 that is configured to operate a chatbot. In some cases, user interface 204 may be local to computing device 208. Alternatively or additionally, in some cases, user interface 204 may remote to computing device 208 and communicative with the computing device 208, by way of one or more networks, such as without limitation the internet. Alternatively or additionally, user interface 204 may communicate with user device 208 using telephonic devices and networks, such as without limitation fax machines, short message service (SMS), or multimedia message service (MMS). Commonly, user interface 204 communicates with computing device 208 using text-based communication, for example without limitation using a character encoding protocol, such as American Standard for Information Interchange (ASCII). Typically, a user interface 204 conversationally interfaces a chatbot, by way of at least a submission 212, from the user interface 208 to the chatbot, and a response 216, from the chatbot to the user interface 204. In many cases, one or both of submission 212 and response 216 are text-based communication. Alternatively or additionally, in some cases, one or both of submission 212 and response 216 are audio-based communication.

Continuing in reference to FIG. 2, a submission 212 once received by computing device 208 operating a chatbot, may be processed by a processor 220. In some embodiments, processor 220 processes a submission 212 using one or more of keyword recognition, pattern matching, and natural language processing. In some embodiments, processor employs real-time learning with evolutionary algorithms. In some cases, processor 220 may retrieve a pre-prepared response from at least a storage component 224, based upon submission 212. Alternatively or additionally, in some embodiments, processor 220 communicates a response 216 without first receiving a submission 212, thereby initiating conversation. In some cases, processor 220 communicates an inquiry to user interface 204; and the processor is configured to process an answer to the inquiry in a following submission 212 from the user interface 204. In some cases, an answer to an inquiry present within a submission 212 from a user device 204 may be used by computing device 104 as an input to another function, for example without limitation at least a feature 108 or at least a preference input 112.

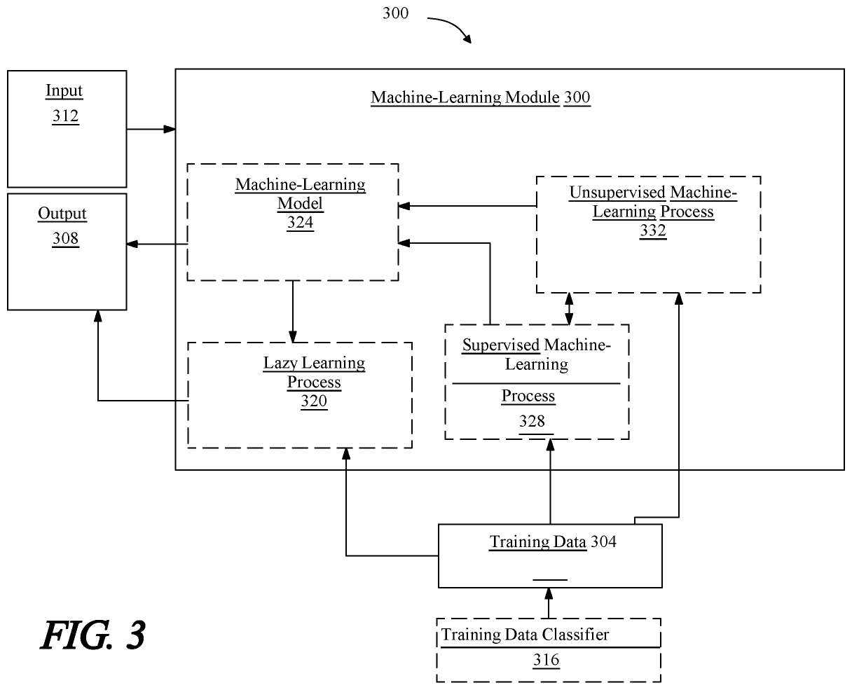

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any input data as described in this disclosure to any output data as described in this disclosure. As a non-limiting illustrative example input data may include attribute data tables and output data may include matching opportunity postings.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 300 may generate a classifier using a classification algorithm, defined as a processes whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 316 may classify elements of training data to categories of opportunity postings.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include attribute data tables as described above as inputs, matching opportunity postings as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

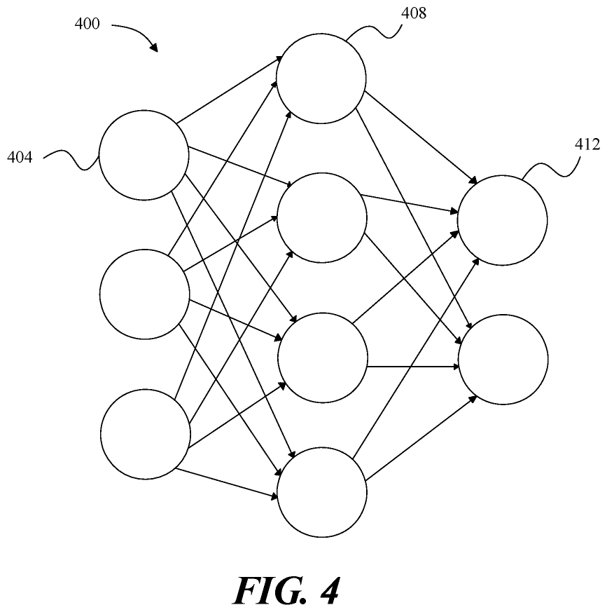

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.”

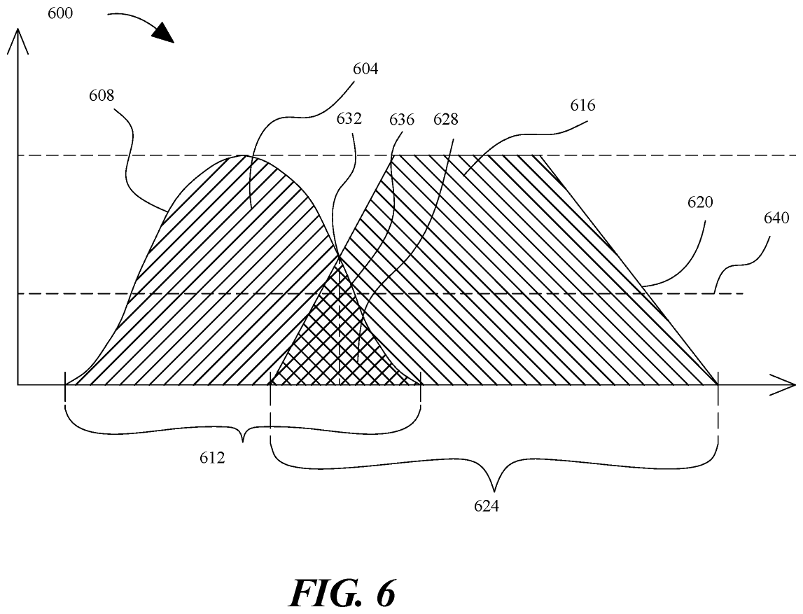

Referring now to FIG. 6, an exemplary embodiment of a node 600 of a neural network is illustrated. Node 600 may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Referring to FIG. 6, an exemplary embodiment of fuzzy set comparison 600 is illustrated. A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , & for x > c and x < a \\ \frac{x - a}{b - a} , & for a \leq x < b \\ \frac{c - x}{c - b} , & if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 6, first fuzzy set 604 may represent any value or combination of values as described above, including output from one or more processes (e.g., machine-learning models), subject-specific data, and description-specific data. A second fuzzy set 616, which may represent any value which may be represented by first fuzzy set 604, may be defined by a second membership function 620 on a second range 624. Second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 628 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, threshold may indicate a sufficient degree of overlap between an output from one or more machine-learning models and/or subject-specific data and a predetermined class, such as without limitation a job description, for combination to occur as described above. Alternatively or additionally, each threshold may be tuned by a machine-learning and/or statistical process, for instance and without limitation as described in further detail below.

Further referring to FIG. 6, in an embodiment, a degree of match between fuzzy sets may be used to classify a subject 120 with at least a job description. For instance, if subject-specific data has a fuzzy set matching a job description fuzzy set by having a degree of overlap exceeding a threshold, computing device 104 may classify the subject as being relevant or otherwise associated with the job description. Where multiple fuzzy matches are performed, degrees of match for each respective fuzzy set may be computed and aggregated through, for instance, addition, averaging, or the like, to determine an overall degree of match.

Still referring to FIG. 6, in an embodiment, subject-specific data may be compared to multiple class fuzzy sets representing job-descriptions. For instance, subject-specific data may be represented by an individual fuzzy set that is compared to each of the multiple class fuzzy sets; and a degree of overlap exceeding a threshold between the individual fuzzy set and any of the multiple class fuzzy sets may cause computing device 104 to classify the subject as belonging to a job description. For instance, in one embodiment there may be two class fuzzy sets, representing a first job description and a second job description. First job description may have a first fuzzy set; second job description may have a second fuzzy set; and subject-specific data may have an individual fuzzy set. Computing device 104, for example, may compare an individual fuzzy set with each of first fuzzy set and second fuzzy set, as described above, and classify a subject to either, both, or neither of first job description nor second job description. Machine-learning methods as described throughout may, in a non-limiting example, generate coefficients used in fuzzy set equations as described above, such as without limitation x, c, and σ of a Gaussian set as described above, as outputs of machine-learning methods. Likewise, subject-specific data may be used indirectly to determine a fuzzy set, as the fuzzy set may be derived from outputs of one or more machine-learning models that take the subject-specific data directly or indirectly as inputs. Although an exemplary application for fuzzy set matching is described above, fuzzy set matching may be used for any classifications or associations described within this disclosure.

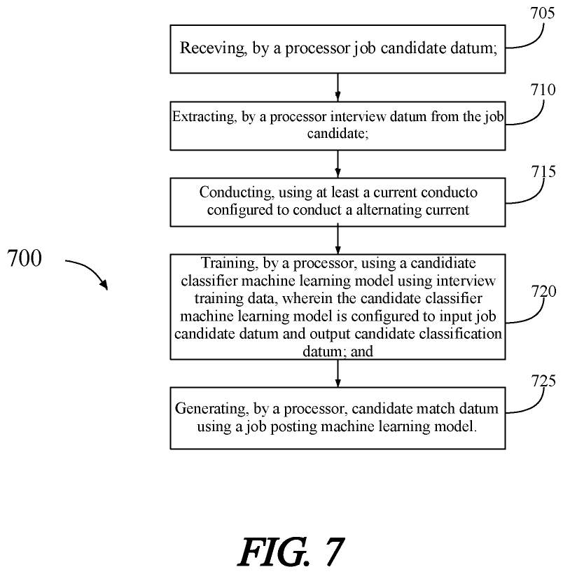

Now referring to FIG. 7, an exemplary method of use for classifying job candidates for a particular job posting. At step 705, method 700 may include receiving, by a processor job candidate datum. Job candidate datum may include any datum described in in this disclosure, for example with reference to FIGS. 1-7.

With continued reference to FIG. 7, at step 710, method 700 may include extracting, by a processor record datum from the job candidate. Record datum may include any datum described in in this disclosure, for example with reference to FIGS. 1-7.

With continued reference to FIG. 7, at step 715, method 700 may include training, by a processor, using a candidate classifier machine learning model using interview training data, wherein the candidate classifier machine learning model is configured to input job candidate datum and output candidate classification datum. Candidate classifier machine learning model may include any machine learning model described in in this disclosure, for example with reference to FIGS. 1-7.

With continued reference to FIG. 7, at step 720, method 700 may include generating, by a processor, candidate match datum using a job posting machine learning model. Job posting machine learning model may include any machine learning model described in in this disclosure, for example with reference to FIGS. 1-7. Candidate match datum may include any datum in in this disclosure, for example with reference to FIGS. 1-7.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

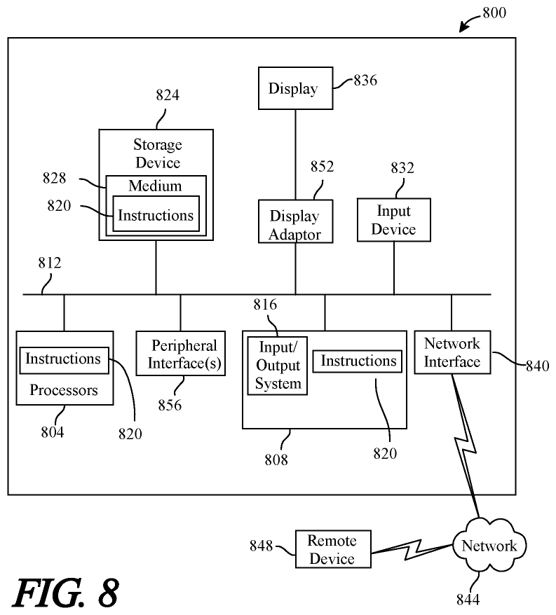

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

1. An apparatus for classifying candidates to postings, wherein the apparatus comprises:
at least a processor; and
a memory communicatively connected to the processor, the memory containing instructions configuring the processor to:
receive a job posting datum associated with a job posting for a job position;
receive job candidate data from an immutable sequential listing, wherein the job candidate data includes at least a video record;
extract a record datum from the at least a video record;
retrieve the record datum using a questionnaire wherein the questionnaire further comprises at least a multiple-choice entry;
classify the record datum to a candidate classification datum, wherein classifying further comprises:
training a candidate classifier using interview training data correlating interview data elements to candidate classification data elements; and
classifying the record datum to the candidate classification datum using the candidate classifier; and
generate a candidate match datum using a posting machine learning model wherein generating the candidate match datum comprises determining a compatibility score as a function of the job posting datum and the job candidate data, wherein the compatibility score comprising a color coding, which comprises a color associated with a level of the compatibility score.

2. The apparatus of claim 1, wherein receiving the candidate data includes receiving the job candidate data using a chatbot.

3. The apparatus of claim 1, wherein the questionnaire further comprises questionnaire responses as a function of an employer input.

4. The apparatus of claim 1, wherein the processor is further configured to transcribe a verbal content.

5. The apparatus of claim 1, wherein the job candidate data includes at least a candidate resume.

6. (canceled)

7. The apparatus of claim 1, wherein the at least a processor is further configured to classify job candidates as a function of a job posting.

8. The apparatus of claim 1, wherein the job candidates are classified as a function of an employer input.

9. (canceled)

10. The apparatus of claim 1, wherein the processor is configured to store the candidate match datum within a database.

11. A method of classifying candidates for to postings, wherein the method comprises:
receiving, by a processor, a job posting datum associated with a job posting for a job position;
receiving, by the processor, job candidate data from an immutable sequential listing, wherein the job candidate data includes at least a video record;
extracting, by the processor, a record datum from the at least a video record;
retrieving, by the processor, the record datum from a questionnaire wherein the questionnaire further comprises at least a multiple-choice entry;
training, by the processor, a candidate classifier using interview training data correlating interview data elements to candidate classification data elements;
classifying, by the processor, the record datum to the candidate classification datum using the candidate classifier; and
generating, by the processor, a candidate match datum using a job posting machine learning model, wherein generating the candidate match datum comprises determining a compatibility score as a function of the job posting datum and the job candidate data, wherein the compatibility score comprising a color coding, which comprises a color associated with a level of the compatibility score.

12. The method of claim 11, wherein receiving the job candidate data includes receiving the job candidate data using a chatbot.

13. The method of claim 11, the questionnaire further comprises questionnaire responses as a function of an employer input.

14. The method of claim 11, wherein the processor is further configured to transcribe a verbal content.

15. The method of claim 11, wherein the job candidate data includes at least a candidate resume.

16. (canceled)

17. The method of claim 11, wherein the at least the processor is further configured to classify job candidates as a function of a job posting.

18. The method of claim 11, wherein the job candidates are classified as a function of an employer input.

19. (canceled)

20. The method of claim 11, wherein the processor is configured to store the candidate match datum within a database.

21. The apparatus of claim 1, wherein determining the compatibility score comprises:
generating a compatibility machine-learning model using training data, wherein the training data correlates inputs and outputs, wherein the inputs comprise job posting datum inputs and job candidate data inputs and the outputs comprise compatibility score outputs; and
determining, using the compatibility machine-learning model, the compatibility score as a function of the job posting datum and the job candidate data.

22. The apparatus of claim 21, wherein the compatibility machine-learning model is configured to obtain the training data by querying a communicatively connected database, the training data comprising past job posting datum inputs and past job candidate data inputs and correlated a past compatibility score outputs of the compatibility machine-learning model.

23. The method of claim 11, wherein determining the compatibility score comprises:
generating a compatibility machine-learning model using training data, wherein the training data correlates inputs and outputs, wherein the inputs comprise job posting datum inputs and job candidate data inputs and the outputs comprise compatibility score outputs; and
determining, using the compatibility machine-learning model, the compatibility score as a function of the job posting datum and the job candidate data.

24. The method of claim 23, wherein the compatibility machine-learning model is configured to obtain the training data by querying a communicatively connected database, the training data comprising past job posting datum inputs and past job candidate data inputs and correlated past compatibility score outputs of the compatibility machine-learning model.
